(19) United States
(12) Patent Application Publication
(10) Pub. No.: US 2021/0066717 A1
(43) Pub. Date: Mar. 4, 2021

(54) ELECTROCHEMICAL DEVICE

(71) Applicant: Panasonic Intellectual Property Management Co., Ltd., Osaka (JP)

(72) Inventors: YUSUKE NAKAMURA, Osaka (JP); MOTOHIRO SAKATA, Osaka (JP); HIDEO SAKATA, Osaka (JP); MASATOSHI TAKESHITA, Osaka (JP)

(21) Appl. No.: 16/977,153

(22) PCT Filed: Mar. 22, 2019
(86) PCT No.: PCT/JP2019/012022

§ 371 Date: Sep. 1, 2020

(30) Foreign Application Priority Data
Mar. 29, 2018 (JP) 2018-063629

(51) Int. Cl. H01M 4/587; H01M 10/0567; H01M 4/62; H01M 10/0525; H01M 4/60; H01G 11/52; H01G 11/48; H01G 11/32; H01G 11/64

(52) U.S. Cl. CPC H01M 4/587; H01M 10/0567; H01M 4/625; H01M 10/0525; H01M 2300/0025; H01G 11/52; H01G 11/48; H01G 11/32; H01G 11/64; H01M 4/602

(57) ABSTRACT

An electrochemical device includes a positive electrode, a negative electrode, a separator disposed between the positive electrode and the negative electrode, and an electrolytic solution. The positive electrode includes a conductive polymer, and the negative electrode includes a negative electrode material. The negative electrode material contains a graphite material, and an interlayer distance (d₀₀₂) of the graphite material ranges from 0.336 nm to 0.338 nm, inclusive.

### TECHNICAL FIELD

The present invention relates to an electrochemical device that includes an active layer containing a conductive polymer.

### BACKGROUND

In recent years, an electrochemical device having performance intermediate between a lithium ion secondary battery and an electric double layer capacitor attracts attention, and for example, use of a conductive polymer as a positive electrode material is considered (for example, PTL 1). The electrochemical device including the conductive polymer as the positive electrode material has a small reaction resistance because it is charged and discharged by adsorption (doping) and desorption (dedoping) of anions. Thus, the electrochemical device has higher output and can be charged and discharged at a higher speed than a general lithium ion secondary battery.

### CITATION LIST

### Patent Literature

PTL 1: Unexamined Japanese Patent Publication No. 2014-35836

### SUMMARY

As a negative electrode material of the electrochemical device, for example, a carbonaceous material that is used as a negative electrode material of lithium ion secondary batteries is considered to be used. The electrochemical device including the carbonaceous material as the negative electrode material is capable of being charged and discharged by storing and releasing lithium ions, similarly to the lithium ion secondary batteries. In a case of the lithium ion secondary batteries, a graphite material among carbonaceous materials is considered to be used in terms of obtaining a high capacity.

On the other hand, in order to get an advantage as a capacitor, which can be charged and discharged at high-speed, the lithium ions are required to be inserted and desorbed at high speed when the carbonaceous material is used as the negative electrode material of the electrochemical device. In regard to this point, it is difficult to use graphite as the carbonaceous material used for the negative electrode material of the electrochemical device. Thus, hard carbon is considered to be used instead.

When a graphite material is used as the negative electrode material of the electrochemical device, the reaction resistance involving the insertion and desorption of the lithium ions into and from the graphite materials is large. This makes it difficult to attain the high-speed charging and discharging. And thus internal resistance (direct current resistance (DCR)) is increased.

In view of the above problems, an electrochemical device according to one aspect of the present invention includes a positive electrode, a negative electrode, a separator disposed between the positive electrode and the negative electrode, and an electrolytic solution. The positive electrode includes a conductive polymer, and the negative electrode includes a negative electrode material. The negative electrode material includes a graphite material, and an interlayer distance d₀₀₂ of the graphite material ranges from 0.336 nm to 0.338 nm, inclusive.

The present invention is capable of achieving an electrochemical device including a graphite material in a negative electrode and having a low internal resistance.

### BRIEF DESCRIPTION OF DRAWINGS

FIG. 1 is a schematic sectional view illustrating an electrochemical device according to one exemplary embodiment of the present invention.

FIG. 2 is a schematic view illustrating a configuration of an electrode group according to the same exemplary embodiment.

### DESCRIPTION OF EMBODIMENT

An electrochemical device according the present exemplary embodiment includes a positive electrode, a negative electrode, a separator disposed between the positive electrode and the negative electrode, and an electrolytic solution. The positive electrode includes a conductive polymer. The negative electrode includes a negative electrode material, and the negative electrode material includes a graphite material. An interlayer distance d₀₀₂ of the graphite material ranges from 0.336 nm to 0.338 nm, inclusive. The conductive polymer as the positive electrode material contributes to the charging and discharging by doping and dedoping of anions in a region near the positive electrode. On the other hand, the graphite material as the negative electrode material contributes to the charging and discharging by storing and releasing cations in a region near the negative electrode. The cations are preferably lithium ions.

Here, the graphite material refers to a carbon material that includes a region having a structure formed by layering carbon atom-containing hexagonal mesh layers. Specific examples of the graphite material include natural graphite, synthetic graphite, and graphitized mesophase carbon particles.

In general, graphite has a crystal structure formed by regularly layering the carbon atom-containing hexagonal mesh layers with a period of two layers. Thus, as an index indicating a degree of growth of the graphite crystal structure, interplanar distance d₀₀₂ between (002) planes (interlayer distance between carbon layers) measured by an X-ray diffraction method is used. Pure graphite, which contains almost no impurity, has an interlayer distance d₀₀₂ of 0.335 nm.

As the carbon material, there can also be a carbon material having a structure formed by layering the carbon atom-containing hexagonal mesh layers with a period of three layers and a carbon material formed by irregularly layering the carbon atom-containing hexagonal mesh layers. The graphite material also includes the carbon materials having such structures. In these cases, the interlayer distance between carbon layers adjacent to each other (even when a corresponding plane index is different from (002)) is regarded as the interlayer distance d₀₀₂.

The electrochemical device including the graphite material as the negative electrode material (negative electrode active material) is capable of attaining a high capacitance. The graphite material, however, has a large reaction resistance in accordance with the insertion and desorption of the lithium ions and a large change in volume in accordance with the charging and discharging. Hence, the internal resistance (DCR) of the electrochemical device increases, and this easily causes degradation of cycle characteristics due to repetitive high-speed charging and discharging, which increases burden on the negative electrode. In contrast, the positive electrode of the electrochemical device allows the adsorption and desorption of the anions to and from the conductive polymer at very high speed, and thus the reaction resistance is little.

Thus, in the electrochemical device including the conductive polymer as the positive electrode material, charging and discharging speed is constrained by property of the negative electrode material.

In the electrochemical device including the conductive polymer as the positive electrode material (positive electrode active material), the conductive polymer swells and expands its volume by absorbing the electrolytic solution along with the doping of the anions. Hence, when the electrochemical device includes the graphite material as the negative electrode active material and the conductive polymer as the positive electrode active material, it is necessary to form room (space) in an electrode group including the positive electrode, the separator, and the negative electrode on top of another, in consideration of the volume expansion of both the graphite material and the conductive polymer. This constrains to form the electrode group closely stacking the positive electrode, the separator, and the negative electrode. Thus, it is difficult to achieve a high capacitance or reduction of size of the electrochemical device.

As described above, it was difficult to achieve a low internal resistance (DCR) in an electrochemical device including the conductive polymer as the positive electrode active material and the graphite material as the negative electrode active material. And thus some creative thinking has been required.

In the electrochemical device according to the present exemplary embodiment, an interlayer distance d₀₀₂ of the graphite material is set to be more than or equal to 0.336 nm, which is a longer interlayer distance between carbon layers than an interlayer distance of pure graphite. In the electrochemical device having this configuration, the change in the volume of the graphite material in accordance with the charging and discharging can be suppressed, and a fast charging and discharging and a high capacitance can be obtained. The electrochemical device further improves the cycle characteristics and has a low DCR.

On the other hand, the capacitance of the electrochemical device decreases as the interlayer distance d₀₀₂ of the graphite material becomes long. The graphite material does not have much fluctuation in potential in accordance with the charging and has characteristics that a change of the potential in accordance with the charging is flat. However, as the interlayer distance of the graphite material is longer, flatness of the potential is lost and a rise of the potential in accordance with the charging increases accordingly. From a viewpoint of maintaining a high capacitance and improving the cycle characteristics making use of the flat change of the potential due to the charging of the graphite material as described later, an interlayer distance d₀₀₂ of the graphite material may be set to be less than or equal to 0.338 nm.

Float charging of the electrochemical device is performed by applying a constant voltage between the positive electrode and the negative electrode of the device. In this case, when the potential of the negative electrode rises along with the charging, the potential of the positive electrode also rises following the rise in the potential of the negative electrode. When the potential of the positive electrode rises, the conductive polymer (for example, a polyaniline) used as the positive electrode active material is easily oxidized.

By using the graphite material having an interlayer distance d₀₀₂ of less than or equal to 0.338 nm, the change in the potential of the negative electrode in accordance with the charging is suppressed, and thus the change in the potential of the positive electrode is also suppressed in the float charging. This suppresses oxidation decomposition of the conductive polymer to reduce a side reaction. In this way, irreversible capacitance is reduced and the cycle characteristics is improved.

Particularly when a polyaniline is used as the conductive polymer, a decrease in the capacitance after the float charging is easily caused because the polyaniline is easily oxidized. By setting the interlayer distance of the graphite material to be in the range of less than or equal to 0.338 nm, the oxidation of the polyaniline is suppressed and thus the cycle characteristics can be improved.

The interlayer distance d₀₀₂ of the graphite material can be adjusted by controlling crystallizability of the graphite material. The graphite material having a desired interlayer distance d₀₀₂ can be obtained by controlling, for example, a temperature during baking, a baking time, and an atmosphere during baking.

The interlayer distance d₀₀₂ is calculated as interplanar spacing between (002) planes that is measured by an X-ray diffraction (XRD) method. Specifically, the X-ray diffraction measurement is performed on a graphite material powder to measure a diffraction peak angle θ corresponding to the (002) plane of graphite. The interlayer distance d₀₀₂ is obtained by substituting a wavelength λ of an X-ray used for the measurement into a Bragg equation 2d sin θ=λ. The X-ray used for the measurement is not limited, but a Cu-Kα ray is precise and is simply usable. When the Cu-Kα ray is used, by removing a Cu-Kβ ray and a Cu-Kα₂ ray with a Ni-made X-ray filter or a monochrometer, use of only a Cu-Kα₁ ray (λ=1.5405 Å) is useful to increase measurement precision.

The polyaniline refers to a polymer including aniline (C₆H₅—NH₂) as a monomer and having an amine structural unit of C₆H₅—NH—C₆H₅—NH— and/or an imine structural unit of C₆H₅—N═C₆H₅═N—. Meanwhile, the polyaniline usable as the conductive polymer is not limited to these examples. The polyaniline includes, for example, a derivative having a benzene ring to a part of which an alkyl group such as a methyl group is attached and a derivative having a benzene ring to a part of which a halogen group or the like is attached, as long as the derivatives are polymers including aniline as a basic skeleton.

The electrolytic solution preferably contains vinylene carbonate (VC). Vinylene carbonate forms a good solid electrolyte interface (SEI) to the graphite material. Further, by containing vinylene carbonate at a concentration of at least more than or equal to 0.1% by mass in a whole amount of the electrolytic solution, co-insertion of a solvent together with the lithium ions in between layers of graphite can be suppressed. Thus, the electrochemical device can attain both a high capacitance and improvement of the cycle characteristics.

On the other hand, by containing vinylene carbonate at a higher concentration in the electrolytic solution, thickness of the SEI increases accordingly, and thus the DCR easily increases. From a viewpoint of maintaining a low DCR, a concentration of vinylene carbonate in the electrolytic solution may be less than or equal to 10% by mass in the whole amount of the electrolytic solution.

The concentration of vinylene carbonate in the electrolytic solution may be more than or equal to 0.1% by mass, more than or equal to 0.5% by mass, more than or equal to 1.5% by mass. The concentration of vinylene carbonate in the electrolytic solution may be less than or equal to 10% by mass, less than or equal to 7.5% by mass, more than or equal to 5% by mass. Any combination of these upper limit values and lower limit values is possible.

The concentration of vinylene carbonate, which is described above, is a value of concentration of vinylene carbonate that is measured in the electrolytic solution taken out from an electrochemical device that has been charged at 25° C. and 3.8 V for 24 hours and has been disassembled thereafter.

A density of the negative electrode material may be less than or equal to 1.0 g/cm³. In the electrochemical device, the negative electrode material having a density in this range allows the lithium ions to easily move so that the reaction resistance reduces. From this configuration, high-speed charging and discharging of the electrochemical device can be achieved, and the DCR can be reduced. Particularly, the DCR in a low-temperature environment (for example −30° C.) can be reduced. It is noted that the above range of the density of the negative electrode material is smaller than a density of a negative electrode material used in normal lithium ion secondary batteries. On the other hand, a decrease in the density of the negative electrode material causes a decrease in discharge capacitance. From a viewpoint of obtaining a sufficient capacitance, a density of the negative electrode material may be more than or equal to 0.33 g/cm³, more preferably more than or equal to 0.5 g/cm³.

Accordingly, the range of the density of the negative electrode material is set to range preferably from 0.33 g/cm³ to 1.0 g/cm³, inclusive, more preferably from 0.5 g/cm³ to 1.0 g/cm³, inclusive. Within the above range, it is possible to achieve the electrochemical device having a low DCR and an excellent discharge capacitance.

Here, the negative electrode material is a part of the negative electrode except for a negative current collector. Thus, when a conducting agent and a binder, which are described later, are used, the negative electrode material includes the conducting agent and the binder in addition to the negative electrode active material. That is, the density of the negative electrode material refers to density of the whole negative electrode material including the conducting agent and the binder in addition to the negative electrode active material. Further, it is noted that the above density of the negative electrode material is a value of density of the negative electrode material in negative electrode that is completely discharged, i.e., density of the negative electrode material in a negative electrode that is taken out from a disassembled electrochemical device and discharged up to 1.5 V with reference to a Li counter electrode.

The negative electrode material preferably includes carbon black. Carbon black is capable of serving as the conducting agent to form a conductive path among particles of the negative electrode active material including the graphite material, and thus reduce the DCR. Further, carbon black can directly contribute to the storage and release of the lithium ions to also serve as the negative electrode active material.

It is preferable to use carbon black that has a specific surface area per mass of more than or equal to 500 m²/g. When a specific surface area per mass of carbon black is more than or equal to 500 m²/g, it is easy to decrease the density of the negative electrode material including the graphite material and carbon black, and reduce the DCR. Further, as described above, it is easy to set the density of the negative electrode material in the range from 0.33 g/cm³ to 1.0 g/cm³, inclusive. As a specific surface area per mass of carbon black is larger, volume density decreases accordingly to allow the lithium ions to easily move. This decreases the DCR.

On the other hand, when a specific surface area per mass of carbon black is more than 1500 m²/g, the lithium ions are easily trapped in carbon black to easily decline the cycle characteristics in the electrochemical device. By setting a specific surface area per mass of carbon black to be less than or equal to 1500 m²/g, the electrochemical device can maintain high cycle characteristics.

Accordingly, from a viewpoint of obtaining a low DCR and high cycle characteristics, a specific surface area per mass of carbon black preferably ranges from 500 m²/g to 1500 m²/g, inclusive. The specific surface area per mass of carbon black may be, for example, more than or equal to 525 m²/g. The specific surface area per mass of carbon black may be less than or equal to 1250 m²/g. As a material having such a specific surface area per mass, ketjen black can be suitably used.

A proportion of carbon black in the negative electrode material may be more than or equal to 3% by mass, more than or equal to 7% by mass. When the concentration of carbon black in the negative electrode material is more than or equal to 3% by mass, a large amount of carbon black attaches to the graphite material and thus form a conductive path to easily reduce the DCR. On the other hand, as the concentration of carbon black in the negative electrode material is a higher, the lithium ions are more easily trapped in carbon black, and thus the cycle characteristics easily decline. In order to maintain high cycle characteristics, a proportion of carbon black in the negative electrode material may be less than or equal to 20% by mass, less than or equal to 12% by mass.

From the viewpoint of obtaining a low DCR and high cycle characteristics, a proportion of carbon black in the negative electrode material preferably ranges from 3% by mass to 20% by mass, inclusive.

Hereinafter, an electrochemical device according to the present exemplary embodiment and a configuration of a method for manufacturing the electrochemical device are more specifically described with appropriate reference to drawings.

### <<Electrochemical Device>>

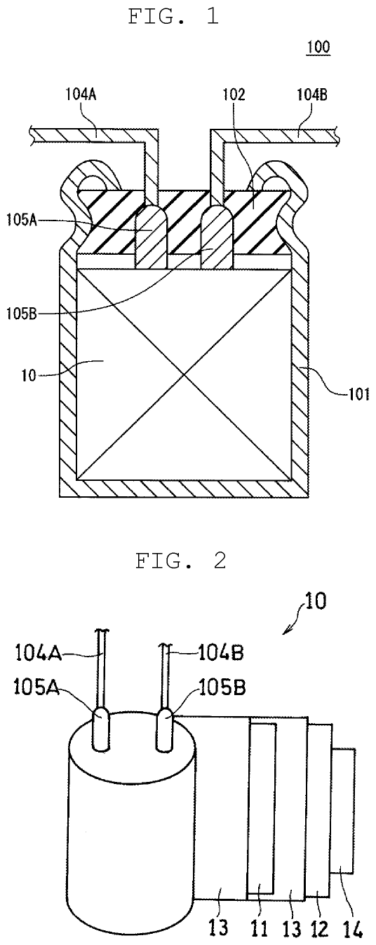

Hereinafter, a configuration of an electrochemical device according to the present invention is described in more detail with reference to drawings. FIG. 1 is a schematic sectional view illustrating electrochemical device 100 according to the present exemplary embodiment, and FIG. 2 is a schematic developed view illustrating a part of electrode group 10 included in electrochemical device 100.

Electrochemical device 100 includes, as illustrated in FIG. 1, electrode group 10, container 101 housing electrode group 10, sealing body 102 sealing an opening of container 101, lead wires 104A, 104B lead out from sealing body 102, and lead tabs 105A, 105B connecting the lead wires to electrodes of electrode group 10, respectively. A part of container 101 near an opening end is drawn inward, and the opening end is curled to swage sealing body 102.

Electrode group 10 includes, as illustrated in FIG. 2, positive electrode 11, negative electrode 12, and separator 13 interposed between the positive electrode and the negative electrode.

### (Positive Electrode)

Positive electrode 11 includes, for example, a positive current collector, a carbon layer formed on the positive current collector, and an active layer formed on the carbon layer. The carbon layer includes a conductive carbon material, and the active layer includes a conductive polymer.

The positive current collector is made of, for example, a metallic material, and a natural oxide covering film is easily formed on a surface of the positive current collector. Thus, in order to reduce resistance between the positive current collector and the active layer, the carbon layer including the conductive carbon material can be formed on the positive current collector. The carbon layer does not have to be formed, but providing the carbon layer enables the resistance between the positive current collector and the active layer to be low. When the active layer is formed by electrolytic polymerization or chemical polymerization, the formation of the active layer is facilitated by the carbon layer.

### (Positive Current Collector)

As the positive current collector, a sheet-shaped metallic material is used, for example. Used as the sheet-shaped metallic material are, for example, a metal foil, a metal porous body, a punched metal, an expanded metal, and an etched metal. As a material for the positive current collector, it is possible to use, for example, aluminum, an aluminum alloy, nickel, and titanium. And aluminum and an aluminum alloy are preferably used.

A thickness of the positive current collector ranges, for example, from 10 μm to 100 μm, inclusive.

### (Carbon Layer)

The carbon layer is formed by, for example, applying a carbon paste containing the conductive carbon material to the surface of the positive current collector to form a coating film and thereafter drying the coating film. The carbon paste is, for example, a mixture containing the conductive carbon material, a polymer material, and water or an organic solvent.

As the polymer material contained in the carbon paste, for example, fluorine resin, acrylic resin, polyvinyl chloride, synthetic rubber (e.g., styrene-butadiene rubber (SBR)), liquid glass (sodium silicate polymer), or imide resin, which are electrochemically stable, are normally used.

As the conductive carbon material, it is possible to use, for example, graphite, hard carbon, soft carbon, and carbon black. Among these conductive carbon materials, carbon black is preferable in terms of easily forming carbon layer 112 that is thin and has excellent conductivity. An average particle diameter D1 of the conductive carbon material is not particularly limited, but ranges, for example, from 3 nm to 500 nm, inclusive, preferably from 10 nm to 100 nm, inclusive. The average particle diameter is a median diameter (D50) in a volume particle size distribution obtained by a laser diffraction particle size distribution measuring apparatus (the same applies hereinafter). The average particle diameter D1 of carbon black may be calculated by observation with a scanning electron microscope.

A thickness of the carbon layer ranges preferably from 0.5 μm to 10 μm, inclusive, more preferably 0.5 μm to 3 μm, inclusive, particularly preferably 0.5 μm to 2 μm, inclusive. The thickness of the carbon layer can be calculated as an average value of any 10 locations on a section of positive electrode 11 that are observed with a scanning electron microscope (SEM). Thickness of the active layer can also be calculated similarly.

### (Active Layer)

The active layer includes a conductive polymer. The active layer is formed by, for example, immersing the positive current collector in a reaction solution containing a raw material monomer of the conductive polymer and then electrolytically polymerizing the raw material monomer in presence of the positive current collector. At this time, the electrolytic polymerization is performed, with the positive current collector set as an anode, to form the active layer including the conductive polymer over a surface of the carbon layer. The thickness of the active layer can be easily controlled by appropriately changing, for example, current density in electrolysis or a polymerization time. The thickness of the active layer ranges, for example, from 10 μm to 300 μm, inclusive.

The active layer may be formed by a method other than the electrolytic polymerization. The active layer including the conductive polymer may be formed by, for example, chemically polymerizing the raw material monomer. Alternatively, the active layer may be formed using a conductive polymer that has been prepared in advance or a dispersion or a solution of the conductive polymer.

The raw material monomer used in the electrolytic polymerization or the chemical polymerization may be any polymerizable compound capable of generating the conductive polymer by the polymerization. The raw material monomer may include an oligomer. As the raw material monomer, for example, aniline, pyrrole, thiophene, furan, thiophene vinylene, pyridine, and derivatives of these monomers are used. A single one or two or more in combination of these raw material monomers may be used. The raw material monomer is preferably aniline in terms of easily forming the active layer on the surface of the carbon layer.

The conductive polymer is preferably a n-conjugated polymer. As the n-conjugated polymer, it is possible to use, for example, polypyrrole, polythiophene, polyfuran, polyaniline, polythiophene vinylene, polypyridine, and derivatives of these polymers. A single one or two or more in combination of these polymers may be used. A weight-average molecular weight of the conductive polymer is not particularly limited and ranges, for example, from 1000 to 100000, inclusive.

Derivatives of polypyrrole, polythiophene, polyfuran, polyaniline, polythiophene vinylene, and polypyridine mean polymers having, as a basic skeleton, polypyrrole, polythiophene, polyfuran, polyaniline, polythiophene vinylene, and polypyridine, respectively. For example, a polythiophene derivative includes poly(3,4-ethylenedioxythiophene) (PEDOT) and the like.

The electrolytic polymerization or the chemical polymerization is preferably performed using a reaction solution containing an anion (dopant). The dispersion liquid or the solution of the conductive polymer also preferably contains a dopant. A π-electron conjugated polymer doped with a dopant exerts excellent conductivity. For example, in the chemical polymerization, the positive current collector may be immersed in a reaction solution containing the dopant, an oxidant, and the raw material monomer, and thereafter picked out from the reaction solution and dried. On the other hand, in the electrolytic polymerization, the positive current collector and an opposite electrode may be immersed in a reaction solution containing the dopant and the raw material monomer while current is flowed between the positive current collector and the opposite electrode, with the positive current collector set as an anode and the opposite electrode as a cathode.

As a solvent of the reaction solution, water may be used, or a nonaqueous solvent may be used in consideration of solubility of the monomer. As the nonaqueous solvent, for example, alcohols such as ethyl alcohol, methyl alcohol, isopropyl alcohol, ethylene glycol, and propylene glycol are preferably used. A dispersion medium or solvent of the conductive polymer is also exemplified by water and the nonaqueous solvents described above.

Examples of the dopant include a sulfate ion, a nitrate ion, a phosphate ion, a borate ion, a benzenesulfonate ion, a naphthalenesulfonate ion, a toluenesulfonate ion, a methanesulfonate ion (CF₃SO₃⁻), a perchlorate ion (ClO₄⁻), a tetrafluoroborate ion (BF₄⁻), a hexafluorophosphate ion (PF₆⁻), a fluorosulfate ion (FSO₃⁻), a bis(fluorosulfonyl)imide ion (N(FSO₂)₂⁻), and a bis(trifluoromethanesulfonyl)imide ion (N(CF₃SO₂)₂⁻). A single one or two or more in combination of these ions may be used.

The dopant may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These polymers may be a homopolymer or a copolymer of two or more monomers. A single one or two or more in combination of these polymer ions may be used.

The reaction solution, or the dispersion liquid of the conductive polymer or the solution of the conductive polymer preferably has a pH ranging from 0 to 4 in terms of easily forming the active layer.

### (Negative Electrode)

The negative electrode includes, for example, a negative current collector and a negative electrode material layer.

As the negative current collector, a sheet-shaped metallic material is used, for example. For example, a metal foil, a metal porous body, a punched metal, an expanded metal, and an etched metal are used as the sheet-shaped metallic material. As a material for the negative current collector, it is possible to use, for example, copper, a copper alloy, nickel, and stainless steel.

The negative electrode material layer preferably includes, as a negative electrode active material, a material that electrochemically stores and releases cations. As such a material, the negative electrode material layer includes a graphite material serving as a main component. An interlayer distance d₀₀₂ of the graphite material ranges from 0.336 nm to 0.338 nm, inclusive. The cations are, for example, lithium ions. A proportion of the graphite material in the negative electrode material layer is, for example, more than or equal to 50% by mass.

In addition, a carbon material other than the graphite material, a metal compound, an alloy, a ceramic material, or the like may be used as the negative electrode active material, together with the graphite material. As the carbon material other than the graphite material, non-graphitizable carbon (hard carbon) and easily graphitizable carbon (soft carbon) are preferable, and hard carbon is particularly preferable. Examples of the metal compound include silicon oxide and tin oxide. Examples of the alloy include a silicon alloy and a tin alloy. Examples of the ceramic material include lithium titanate and lithium manganate. A single one or two or more in combination of these materials may be used. Among these materials, a carbon material is preferable in terms of being capable of decreasing the potential of negative electrode 12.

The negative electrode material layer preferably includes a conducting agent, a binder, or the like in addition to the negative electrode active material. Examples of the conducting agent include carbon black and a carbon fiber. Examples of the binder include a fluorine resin, an acrylic resin, a rubber material, and a cellulose derivative. Examples of the fluorine resin include polyvinylidene fluoride, polytetrafluoroethylene, and a tetrafluoroethylene-hexafluoropropylene copolymer. Examples of the acrylic resin include polyacrylic acid and an acrylic acid-methacrylic acid copolymer. Examples of the rubber material include styrene-butadiene rubber, and examples of the cellulose derivative include carboxymethyl cellulose.

The negative electrode material layer is formed by, for example, mixing the negative electrode active material, the conducting agent, the binder, and the like with a dispersion medium to prepare a negative electrode mixture paste, and applying the negative electrode mixture paste to the negative current collector and then drying the negative electrode mixture paste.

When lithium ions are used as the cations, the negative electrode is preferably pre-doped with the lithium ions in advance. This decreases the potential of the negative electrode. Hence, a difference in potential (that is, voltage) between the positive electrode and the negative electrode is increased, and thus energy density of the electrochemical device is improved.

Pre-doping of the negative electrode with the lithium ions is progressed by, for example, forming a metallic lithium layer that is to serve as a supply source of the lithium ions on a surface of the negative electrode material layer and impregnating the negative electrode including the metallic lithium layer with an electrolytic solution (e.g., a nonaqueous electrolytic solution) having lithium-ion conductivity. At this time, the lithium ions are eluted from the metallic lithium layer into the nonaqueous electrolytic solution, and the eluted lithium ions are stored in the negative electrode active material. For example, when graphite or hard carbon is used as the negative electrode active material, the lithium ions are inserted in between layers of the graphite or in fine pores of the hard carbon. An amount of the pre-doping lithium ions can be controlled by a mass of the metallic lithium layer.

The step of pre-doping the negative electrode with the lithium ions may be performed before assembling the electrode group, or the pre-doping may be progressed after the electrode group is housed together with the nonaqueous electrolytic solution in a case of the electrochemical device.

### (Separator)

For example, a nonwoven fabric made of cellulose fiber, a nonwoven fabric made of glass fiber, a microporous membrane made of polyolefin, a fabric cloth, and a nonwoven fabric are preferably used as the separator. Examples of a fiber constituting the fabric cloth and the nonwoven fabric include a polymer fiber such as polyolefin, a cellulose fiber, and a glass fiber. These materials may be used in combination.

A thickness of the separator has ranges, for example, from 10 μm to 300 μm, inclusive. The thickness of separator 13 that is a microporous membrane ranges, for example, from 10 μm to 40 μm, inclusive. The thickness of the separator that is a fabric cloth or a nonwoven fabric ranges, for example, from 100 μm to 300 μm, inclusive.

### (Electrolytic Solution)

The electrode group is impregnated with a nonaqueous electrolytic solution.

The nonaqueous electrolytic solution has lithium-ion conductivity and contains a lithium salt and a nonaqueous solvent that dissolves the lithium salt. In this case, anions of the lithium salt can reversibly repeat doping and dedoping to and from the positive electrode. On the other hand, lithium ions derived from the lithium salt are reversibly stored and released in and from the negative electrode.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. A single one or two or more in combination of these lithium salts may be used. Among these lithium salts, it is preferable to use at least one selected from the group consisting of a lithium salt having a halogen atom-containing oxo acid anion suitable as an anion, and a lithium salt having an imide anion. A concentration of the lithium salt in the nonaqueous electrolytic solution may range, for example, from 0.2 mol/L to 4 mol/L, inclusive, and is not particularly limited.

As the nonaqueous solvent, it is possible to use, for example, cyclic carbonates such as ethylene carbonate, propylene carbonate, and butylene carbonate; chain carbonates such as dimethyl carbonate, diethyl carbonate, and ethyl methyl carbonate; aliphatic carboxylate esters such as methyl formate, methyl acetate, methyl propionate, and ethyl propionate; lactones such as γ-butyrolactone and γ-valerolactone; chain ethers such as 1,2-dimethoxyethane (DME), 1,2-diethoxyethane (DEE), and ethoxymethoxyethane (EME); cyclic ethers such as tetrahydrofuran and 2-methyltetrahydrofuran; dimethylsulfoxide, 1,3-dioxolane, formamide, acetamide, dimethylformamide, dioxolane, acetonitrile, propionitrile, nitromethane, ethylmonoglyme, trimethoxymethane, sulfolane, methyl sulfolane, and 1,3-propanesultone. A single one or two or more in combination of these solvents may be used.

The nonaqueous electrolytic solution may be prepared by adding an additive agent to the nonaqueous solvent as necessary. For example, an unsaturated carbonate such as vinylene carbonate, vinyl ethylene carbonate, or divinyl ethylene carbonate may be added as an additive agent for forming a covering film having high lithium-ion conductivity on a surface of the negative electrode.

Particularly, when the graphite material is used as the negative electrode material, use of vinylene carbonate is capable of suppressing co-insertion of the solvent into the graphite material to enable the electrochemical device to maintain a low DCR.

### (Manufacturing Method)

Hereinafter, one example of a method for manufacturing the electrochemical device of the present invention is described with reference to FIGS. 1 and 2. The method for manufacturing the electrochemical device of the present invention, however, is not limited to this example.

Electrochemical device 100 is manufactured by a method including the following steps, for example. The steps are applying a carbon paste to a positive current collector to form a coating film and then drying the coating film to form a carbon layer; obtaining positive electrode 11 by forming an active layer containing a conductive polymer on the carbon layer; and stacking obtained positive electrode 11, separator 13, and negative electrode 12 in this order. Further, electrode group 10 obtained by stacking positive electrode 11, separator 13, and negative electrode 12 in this order is housed together with a nonaqueous electrolytic solution in container 101. Usually, the active layer is formed in an acidic atmosphere due to an influence of an oxidant or a dopant used.

A method for applying the carbon paste to the positive current collector is not particularly limited, and examples of the method include common application methods such as a screen printing method, a coating method using various coaters, e.g., a blade coater, a knife coater, and a gravure coater, and a spin coating method.

The active layer is, as described above, formed by, for example, electrolytically polymerizing or chemically polymerizing a raw material monomer in presence of the positive current collector including the carbon layer. Alternatively, the active layer is formed by coating the positive current collector including the carbon layer with, for example, a solution containing a conductive polymer or a dispersion of a conductive polymer.

A lead member (lead tab 105A equipped with lead wire 104A) is connected to positive electrode 11 obtained as described above, and the other lead member (lead tab 105B equipped with lead wire 104B) is connected to negative electrode 12. Subsequently, positive electrode 11 and negative electrode 12 to which these lead members are connected are wound, with separator 13 interposed between the positive electrode and the negative electrode, to give electrode group 10 that is illustrated in FIG. 2 and exposes the lead members from one end surface of the electrode group. An outermost periphery of electrode group 10 is fixed with fastening tape 14.

Next, as illustrated in FIG. 1, electrode group 10 is housed together with a nonaqueous electrolytic solution (not illustrated) in bottomed cylindrical container 101 having an opening. Lead wires 104A, 104B are led out from sealing body 102. Sealing body 102 is disposed in the opening of container 101 to seal container 101. Specifically, container 101 is, at a part near an opening end, drawn inward, and is, at the opening end, curled to swage sealing body 102. Sealing body 102 is formed of, for example, an elastic material containing a rubber component.

In the exemplary embodiment, a wound cylinder-shaped electrochemical device has been described. An application range of the present invention, however, is not limited to the example described above, and the present invention is also applicable to a square or rectangle-shaped wound or stacked electrochemical device.

### EXAMPLES

Hereinafter, the present invention is described in more detail based on examples. The present invention, however, is not to be limited to the examples.

### <<Electrochemical Device A1>>

### (1) Production of Positive Electrode

A 30-μm-thick aluminum foil was prepared as a positive current collector. On the other hand, an aqueous aniline solution containing aniline and sulfuric acid was prepared.

A carbon paste was prepared by kneading with water a mixture powder containing 11 parts by mass of carbon black and 7 parts by mass of polypropylene resin particles. The obtained carbon paste was applied to entire front and back surfaces of the positive current collector and then dried by heating to form a carbon layer. The carbon layer had a thickness of 2 μm per one surface.

The positive current collector on which the carbon layer had been formed and an opposite electrode were immersed in an aqueous aniline solution, and electrolytic polymerization was performed at a current density of 10 mA/cm² for 20 minutes to attach a film of a conductive polymer (polyaniline) doped with sulfate ions (SO₄²⁻) onto the carbon layers on the front and back surfaces of the positive current collector.

The conductive polymer doped with sulfate ions was reduced for dedoping of the doping sulfate ions. Thus, an active layer was formed, containing the conductive polymer that had been subjected to dedoping of the sulfate ions. Next, the active layer was sufficiently washed and thereafter dried. The active layer had a thickness of 35 μm per one surface.

### (2) Synthesis of Graphite Material

5 parts by weight of para-xylene glycol and 1 part by weight of boron carbide were added to 100 parts by weight of coal mesophase pitch, and the mixture was melted by heating to 290° C. at atmospheric pressure and polymerized for 3 hours. The polymerized pitch was carbonized in a nitrogen atmosphere at 1000° C. for 1 hour. After the carbonization, the pitch was pulverized to be carbon particles by a jet mill so that the carbon particles had a median diameter D50 of 10.5 μm. The obtained carbon particles were further baked in an argon atmosphere at 2300° C. for 1 hour to give a graphite material X1.

The interlayer distance d₀₀₂ of the graphite material X1 calculated by the X-ray diffraction measurement was 0.336 nm.

### (3) Production of Negative Electrode

A 10-μm-thick copper foil was prepared as a negative current collector. In the meantime, a mixture powder was obtained by mixing 89.5 parts by mass of graphite, 3.0 parts by mass of ketjen black (specific surface area 525 m²/g) as carbon black, 3.5 parts by mass of carboxymethyl cellulose, and 4.0 parts by mass of styrene-butadiene rubber. The mixture powder and water were mixed at a ratio by weight (mixture powder:water) of 40:60 to prepare a negative electrode mixture paste. The negative electrode mixture paste was applied to both surfaces of the negative current collector and dried to give a negative electrode including a 35-μm-thick negative electrode material layer on both surfaces. Next, a metallic lithium foil was attached to the negative electrode material layer in an amount calculated so that the negative electrode that had been pre-doped and was in an electrolytic solution had a potential of less than or equal to 0.2 V with respect to a potential of metallic lithium.

The density of the negative electrode material was calculated as 0.86 g/cm³ from thickness and mass of the dried negative electrode material layer.

### (4) Production of Electrode Group

Lead tabs were respectively connected to the positive electrode and the negative electrode, and then, as illustrated in FIG. 2, a stacked body obtained by alternately stacking a nonwoven fabric separator (thickness 35 μm) made of cellulose, the positive electrode, and the negative electrode was wound to form an electrode group.

### (5) Preparation of Nonaqueous Electrolytic Solution

A solvent was prepared by adding vinylene carbonate to a mixture containing propylene carbonate and dimethyl carbonate at a ratio by volume of 1:1 so that a proportion of vinylene carbonate in an entire amount of an electrolytic solution after pre-doping of lithium ions is 0.1% by mass. LiPF₆ was dissolved as a lithium salt in the obtained solvent at a prescribed concentration to prepare a nonaqueous electrolytic solution containing a hexafluoro phosphate ions (PF₆⁻) as an anion.

### (6) Production of Electrochemical Device

The electrode group and the nonaqueous electrolytic solution were housed in a bottomed container having an opening to assemble the electrochemical device illustrated in FIG. 1. Thereafter, the electrochemical device was aged under application of a charging voltage of 3.8 V between terminals of the positive electrode and the negative electrode at 25° C. for 24 hours and allowed pre-doping of the negative electrode with lithium ions to be progressed. Thus, an electrochemical device A1 was produced.

### <<Electrochemical Devices A2 to A18>>

A graphite material X2 was obtained by changing the baking temperature of the carbon particles from 2300° C. to 2100° C. in the synthesis of the graphite material X1. The interlayer distance d₀₀₂ of the graphite material X2 calculated by the X-ray diffraction measurement was 0.337 nm.

Similarly, graphite materials X3 to X5 were obtained by changing the baking temperature of the carbon particles to 1900° C., 1800° C., and 2400° C., respectively in the synthesis of the graphite material X1. The interlayer distance d₀₀₂ of the graphite materials X3 to X5 was 0.338 nm, 0.339 nm, and 0.3356 nm, respectively.

Further, ketjen black was prepared that had a different specific surface area from the specific surface area of the one used in the electrochemical device A1.

Electrochemical devices A2 to A18 were produced similarly to the production of the electrochemical device A1 but by selecting a graphite material from among the graphite materials X1 to X5 and changing the blending amount and the specific surface area of ketjen black, the density of the negative electrode material, and the content proportion of vinylene carbonate in the preparation of the electrolytic solution.

When the blending amount of ketjen black was changed from the blending amount in the electrochemical device A1, the blending amounts of carboxymethyl cellulose and styrene-butadiene rubber in the negative electrode mixture paste were not changed but the blending amount of the graphite material was changed according to the blending amount of ketjen black.

Table 1 shows details of the electrochemical devices A1 to A18, i.e., the interlayer distance d₀₀₂ of the graphite material, the blending amount (concentration) and the specific surface area of carbon black, the density of the negative electrode material, and the content proportion of vinylene carbonate (VC) in the preparation of the electrolytic solution.

The obtained electrochemical devices A1 to A18 were evaluated by the following methods.

### [Evaluations]

### (1) Internal Resistance (DCR)

An initial internal resistance (initial DCR) was obtained from an amount of voltage drop when the electrochemical device was charged at a voltage of 3.8 V and then discharged for a prescribed time.

### (2) Cycle Characteristics

The electrochemical device was charged at a voltage of 3.8 V and then discharged at a current of 5.0 A up to 2.5 V. A discharge amount flowed halfway through the discharging, that is, while the voltage is decreased from 3.3 V to 3.0 V was divided by the voltage change ΔV (=0.3 V), and the obtained value was defined as an initial capacitance C₀ (F).

A cycle of the charging and the discharging was repeated 100000 times. A capacitance C₁ at the 100000th cycle was obtained similarly to the initial capacitance C₀, and a ratio (%) of the 100000th-cycle capacitance C₁ to the initial capacitance C₀ was evaluated as a capacitance retention rate. That is, a capacitance retention rate R was evaluated by R=C₁/C₀×100.

Table 2 shows evaluation results of the initial capacitance C₀, the initial DCR, and the cycle retention rate R of the electrochemical devices A1 to A18.

TABLE 1

| | | Carbon black | | Negative | Content |
|---|---|---|---|---|---|
| | | | Specific | electrode | proportion of |
| Electro- | | Concen- | surface | material | vinylene |
| chemical | d₀₀₂/ | tration/ | area/ | density/ | carbonate/ |
| device | [nm] | [% by mass] | [m²/g] | [g/cm³] | [% by mass] |
| A1 | 0.336 | 3.0 | 525 | 0.86 | 0.1 |
| A2 | 0.337 | 3.0 | 525 | 0.85 | 0.1 |
| A3 | 0.338 | 3.0 | 525 | 0.89 | 0.1 |
| A4 | 0.339 | 3.0 | 525 | 0.89 | 0.1 |
| A5 | 0.3356 | 3.0 | 525 | 0.89 | 0.1 |
| A6 | 0.3356 | 2.5 | 525 | 1.01 | 0.1 |
| A7 | 0.337 | 7.5 | 525 | 0.70 | 0.1 |
| A8 | 0.337 | 12.0 | 525 | 0.54 | 0.1 |
| A9 | 0.337 | 20.0 | 525 | 0.33 | 0.1 |
| A10 | 0.337 | 7.5 | 1250 | 0.66 | 0.1 |
| A11 | 0.337 | 7.5 | 1500 | 0.47 | 0.1 |
| A12 | 0.337 | 7.5 | 1250 | 0.66 | 0.5 |
| A13 | 0.337 | 7.5 | 1250 | 0.66 | 1.5 |
| A14 | 0.337 | 7.5 | 1250 | 0.66 | 5.0 |
| A15 | 0.337 | 7.5 | 1250 | 0.66 | 7.5 |
| A16 | 0.337 | 7.5 | 1250 | 0.66 | 10.0 |
| A17 | 0.3356 | 7.5 | 370 | 1.09 | 0.1 |
| A18 | 0.3356 | 7.5 | 1250 | 0.70 | 12.0 |

TABLE 2

| | | | Capacitance |
|---|---|---|---|
| Electrochemical | Initial capacitance | DCR/ | retention rate R |
| device | C₀/[F] | [mΩ] | after 100000 cycles |
| A1 | 710 | 10.3 | 84 |
| A2 | 715 | 10.5 | 85 |
| A3 | 713 | 10.4 | 86 |
| A4 | 623 | 9.9 | 89 |
| A5 | 710 | 11.2 | 65 |
| A6 | 713 | 17.1 | 62 |
| A7 | 708 | 10.1 | 87 |
| A8 | 711 | 10.0 | 85 |
| A9 | 716 | 9.8 | 87 |
| A10 | 705 | 10.0 | 88 |
| A11 | 715 | 9.8 | 83 |
| A12 | 718 | 10.2 | 87 |
| A13 | 711 | 10.1 | 85 |
| A14 | 703 | 10.4 | 87 |
| A15 | 710 | 10.9 | 84 |
| A16 | 712 | 10.5 | 88 |
| A17 | 704 | 17.5 | 67 |
| A18 | 667 | 17.5 | 68 |

In comparison among the electrochemical devices A1 to A5, when an interlayer distance d₀₀₂ of the graphite material is in the range from 0.336 nm to 0.338 nm, inclusive, the electrochemical device is capable of maintaining a high initial capacitance, a low DCR, and excellent cycle characteristics.

In the electrochemical device A4, the DCR was low but the initial capacitance C₀ was decreased. This is considered to be due to an interlayer distance d₀₀₂ of 0.339 nm that is slightly wide. On the other hand, in the electrochemical device A5, the capacitance retention rate R was decreased. This is considered to be due to an interlayer distance d₀₀₂ of 0.3356 nm that leads to a large change in volume on the negative electrode side in accordance with the charging and discharging. In comparison between the devices A5 and A6, when the concentration of carbon black is less than 3% by mass, the DCR is easily increased.

Next, the electrochemical devices A2 and A7 to A9 are compared with each other. These electrochemical devices are common in the interlayer distance d₀₀₂ of the graphite material, the specific surface area of carbon black, and the content proportion of vinylene carbonate, but is different in the concentration of carbon black. The electrochemical devices A2 and A7 to A9 having a concentration of carbon black in the range from 3% by mass to 20% by mass are capable of maintaining a high initial capacitance, a remarkably reduced DCR, and excellent cycle characteristics.

Further, the electrochemical devices A2 and A7 to A9 clarify that both a low DCR and a high capacitance retention rate are attainable by setting the density of the negative electrode material in the range from 0.33 g/cm³ to 1.0 g/cm³. The electrochemical devices A6 and A17 are incapable of obtaining a low DCR because not only the interlayer distance d₀₀₂ is 0.3356 nm but also the density of the negative electrode material is more than 1.0 g cm³ to increase the resistance for the movement of the lithium ions.

Next, the electrochemical devices A7, A10, and A11 are compared with each other. These electrochemical devices are common in the interlayer distance d₀₀₂ of the graphite material, the concentration of carbon black, and the content proportion of vinylene carbonate, but is different in the specific surface area of carbon black. The electrochemical devices A7, A10, and A11 that contains carbon black having a specific surface area in the range from 500 m²/g to 1500 m²/g are capable of maintaining a high initial capacitance, a remarkably reduced DCR, and excellent cycle characteristics.

Further, the electrochemical devices A10 and A12 to A16 are compared with each other. These electrochemical devices are common in the interlayer distance d₀₀₂ of the graphite material, and the concentration and the specific surface area of carbon black, but is different in the content proportion of vinylene carbonate. The electrochemical devices A10 and A12 to A16 having a content proportion of vinylene carbonate in the range from 0.1% by mass to 10% by mass are capable of maintaining a high initial capacitance, a remarkably reduced DCR, and excellent cycle characteristics. In the electrochemical device A18, the initial capacitance is decreased and the DCR is high. This is considered to be because not only the interlayer distance d₀₀₂ is 0.3356 nm but also the formed SEI has a large film thickness to be resistance for the movement of lithium.

### INDUSTRIAL APPLICABILITY

An electrochemical device according to the present invention has a low DCR and is therefore suitable as various electrochemical devices, particularly as a back-up power source.

### REFERENCE MARKS IN THE DRAWINGS

10: electrode group
11: positive electrode
12: negative electrode
13: separator
14: fastening tape
100: electrochemical device
101: container
102: sealing body
104A, 104B: lead wire
105A, 105B: lead tab

1. An electrochemical device comprising:
a positive electrode;
a negative electrode;
a separator disposed between the positive electrode and the negative electrode; and
an electrolytic solution, wherein:
the positive electrode includes a conductive polymer,
the negative electrode includes a negative electrode material,
the negative electrode material includes a graphite material, and
an interlayer distance d₀₀₂ of the graphite material ranges from 0.336 nm to 0.338 nm, inclusive.

2. The electrochemical device according to claim 1, wherein the conductive polymer includes a polyaniline.

3. The electrochemical device according to claim 1, wherein:
the electrolytic solution includes vinylene carbonate, and
a concentration of the vinylene carbonate in the electrolytic solution ranges from 0.1% by mass to 10% by mass, inclusive.

4. The electrochemical device according to claim 1, wherein a density of the negative electrode material ranges from 0.33 g/cm³ to 1.0 g/cm³, inclusive.

5. The electrochemical device according to claim 1, wherein
the negative electrode material includes carbon black, and
a specific surface area per mass of the carbon black ranges from 500 m²/g to 1500 m²/g, inclusive.

6. The electrochemical device according to claim 5, wherein a proportion of the carbon black in the negative electrode material ranges from 3% by mass to 20% by mass, inclusive.
